(19) United States
(12) Patent Application Publication
(10) Pub. No.: US 2002/0050712 A1
(43) Pub. Date: May 2, 2002

(54) Stopper-notch-provided product catalog

(76) Inventor: Hideki Kurosu, Shimotsuma-City (JP)

Correspondence Address: ARMSTRONG,WESTERMAN & HATTORI, LLP, 1725 K STREET, NW., SUITE 1000, WASHINGTON, DC, 20006, US

(21) Appl. No.: 09/946,134

(22) Filed: Sep. 5, 2001

(30) Foreign Application Priority Data
Sep. 6, 2000 (JP) 2000-269926

(51) Int. Cl. B42D 15/00

(52) U.S. Cl. 283/63.1

(57) ABSTRACT

The invention relates to an improvement of thick product catalogs which show various kinds of house appliances, house hardware, farming equipments, etc and are produced for the purpose of sales promotion.

A stopper-notch-provided product catalog has a structure characterized in that a stopper notch of a nearly U shape is formed across in a left end portion of a top side at a position of 1.5 cm to 2 cm rightward from a left end in such a way that the stopper notch has a width of about 2 to 3 cm and a surface of a finger tip fits inside.

### DETAILED DESCRIPTION OF THE INVENTION

1. Field of Utilization in Industry

The present invention relates to an improvement of thick product catalogs which show various kinds of house appliances, house hardware, farming equipments, etc. and are produced for the purpose of sales promotion.

2. Prior Arts

Conventionally, to arrange product catalogs in order, a number of very thick and heavy product catalogs which show various kinds of house appliances, house hardware, farming equipments, etc. and are produced for the purpose of sales promotion were stored side by side in a product catalog storage rack without space and close to one another.

Problems to be Solved by the Invention

If multiple product catalogs are stored in a product catalog storage rack without space and close to one another, however, the seamless and close storage makes it very difficult to take out a necessary product catalog when needed.

If one tries to apply force at the tip of a finger and forcibly pull out a catalog with a nail, the tip of the nail may be tore away or the surface of the finger tip may be injured and bleed.

To overcome the problems, therefore, it is an object of the invention to provide product catalogs that can pulled out very easily by hooking a finger tip thereon even when the product catalogs are stored in a product catalog storage rack without space and close to one another.

Means for Solving the Problem

A stopper-notch-provided product catalog according to the invention has a structure characterized in that a stopper notch of a nearly U shape is formed across in a left end portion of a top side at a position of 15 cm to 2 cm rightward from a left end in such a way that the stopper notch has a width of about 2 to 3 cm and a surface of a finger tip fits inside.

Embodiments

A stopper-notch-provided product catalog according to the invention is elaborated below with reference to the accompanying drawings, FIG. 1 is a front view of a stopper-notch-provided product catalog of the invention, and FIG. 2 is a plan view of the stopper-notch-provided product catalog of the invention.

As shown in FIG. 1, a stopper-notch-provided product catalog 1 of the invention has a stopper notch 1b of a nearly U shape or semicircular shape formed at a distance a of 1 cm to 2 cm from a left end. 1e of a top side 1a of the product catalog 1. The stopper notch 1b to be formed has a notch width b of 2 cm to 3 cm

The distance a from of 1 to 2 cm from the left end 1e to where the stopper notch 1b is formed plus the notch width b of the stopper notch 1b formed in a nearly U shape or semicircular shape is equivalent to the length to the first joint of a finger

FIG. 3 is a diagram showing stopper-notch-provided product catalogs of the invention put in a stopper-notch-provided product catalog storage rack for storing stopper-notch-provided product catalogs. As apparent from FIG. 3, the stopper-notch-provided product catalogs 1 are arranged in the stopper-notch-provided product catalog storage rack 2 without space and close to one another.

Even if multiple stopper-notch-provided product catalogs 1, 1, 1, 1, . . . are put on partition shelves 2a without space and close to one another in such a way, a product catalog can be pulled out very easily

FIG. 4 is a diagram showing a stopper-notch-provided product catalog 1 pulled out of the stopper-notch-provided product catalog storage rack using the force at a finger tip closely fitted in the stopper notch formed in a U shape or semicircular shape it the product catalog.

A finger tip surface 8a of a finger 8 is pressed against the stopper notch 1b of one of the stopper-notch-provided product catalogs 1, 1, 1, 1, . . . arranged in order in the stopper-notch-provided product catalog storage rack 2, with sore force.

With the finger tip surface 8a pressed against the stopper notch 1b formed in a U shape or the stopper notch 1b formed in a semicircular shape, one pulls the stopper-notch-provided product catalog 1, 1, 1, 1, . . . out of the stopper-notch-provided product catalog storage rack 2 by pulling and tilting the product catalog out in such a way as to turn it in the direction of an arrow a.

FIGS. 5 to 8 are diagrams showing modifications of the stopper notch formed in the stopper-notch-provided product catalog of the invention.

In a stopper-notch-provided product catalog 3 shown in FIG. 5, the stopper notch 1b is formed in a nearly L shape That is, a portion of the stopper notch 1b closer to the rear side 1e is made shallower and a portion of the stopper notch 1b closer to a front side 1c is made deeper.

In a stopper-notch-provided product catalog 4 shown in FIG. 6, the stopper notch 1b is formed in a V shape. In a stopper-notch-provided product catalog 5 shown in FIG. 7, the stopper notch 1b is formed in a rectangular recess shape.

In a stopper-notch-provided product catalog 6 shown in FIG. 8, the stopper notch 1b is formed in a nearly L shape. That is, a portion of the stopper notch 1b closer to the rear side 1e is made deeper and a portion of the stopper notch 1b closer to the front side 1c is made shallower.

In a stopper-notch-provided product catalog 7 shown in FIG. 9, the stopper notch 1b is formed in a semicircular shape and provided with recesses and projections.

Although product catalogs have been described as an example in the description of the stopper-notch-provided product catalog 1 of the invention, the stopper notch may be formed in ordinary books as well as telephone books, time tables, comic books and other books: or the like in place of the product catalogs.

Effect of the Invention

Because of the above-described structures, the invention has the following effect. First, eves if thick product catalogs are stored in a product catalog storage rack without space and close to one another, a product catalog an be pulled out easily by hooking a finger tip surface on the stopper notch formed in the stopper-notch-provided product

Secondly, as the product catalog is pulled out with a finger tip surface pressed against the stopper notch, one can avoid injuring the skin of the finger tip surface or the nail of a finger.

### BRIEF DESCRIPTION OF THE DRAWINGS

FIG. 1

FIG. 1 is a front view of the stopper-notch-provided product catalog of the invention.

FIG. 2

FIG. 2 is a top view of the stopper-notch-provided product catalog of the inventions

FIG. 3

FIG. 3 is a diagram showing the stopper-notch-provided product catalogs of the invention put in stopper-notch-provided product catalog storage rack 2 without space and close to one another.

FIG. 4

FIG. 4 is a diagram showing one stopper-notch-provided product catalog pulled out of the stopper-notch-provided product catalog storage rack with the stopper-notch-provided product catalogs of the invention put without space and close to one another.

FIG. 5

FIG. 5 is a front view of another embodiment of the stopper-notch-provided product catalog of the invention.

FIG. 6

FIG. 6 is a front view of a different embodiment of the stopper-notch-provided product catalog of the invention.

FIG. 7

FIG. 7 is a front view of a further embodiment of the stopper-notch-provided product catalog of the invention.

FIG. 8

FIG. 8 is a front view of a still further embodiment of the stopper-notch-provided product catalog of the invention.

FIG. 9

FIG. 9 is a front view of a yet still further embodiment of the stopper-notch-provided product catalog of the invention.

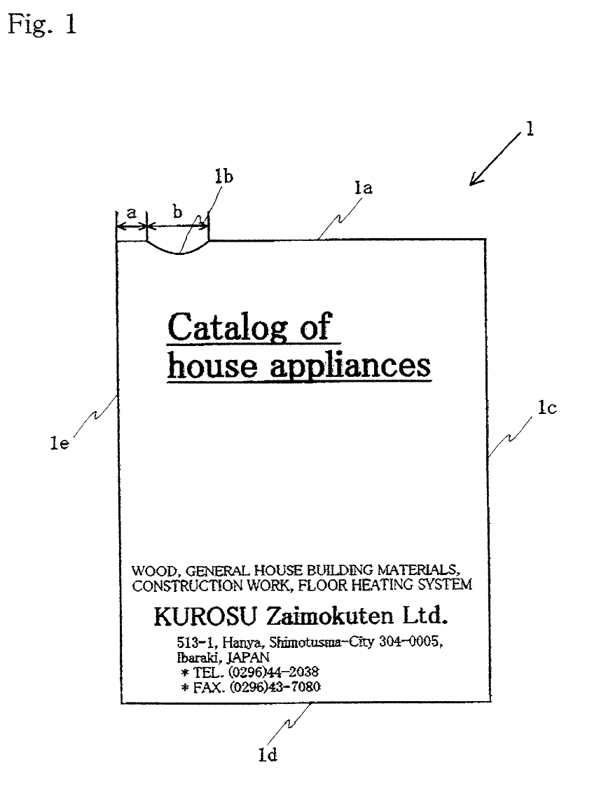

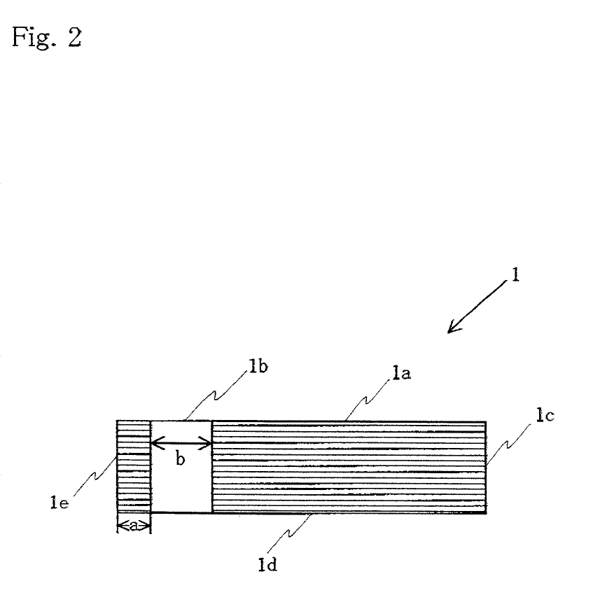

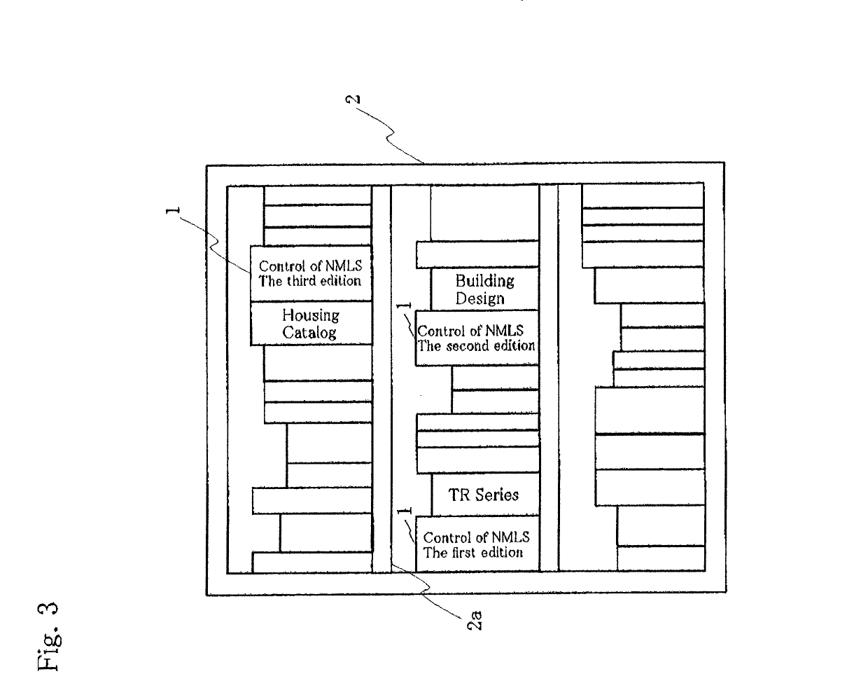

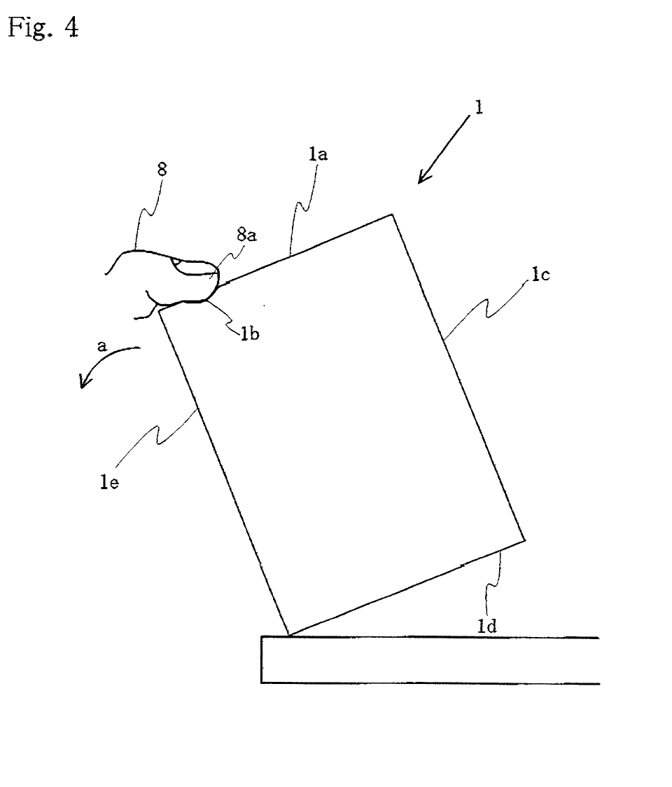

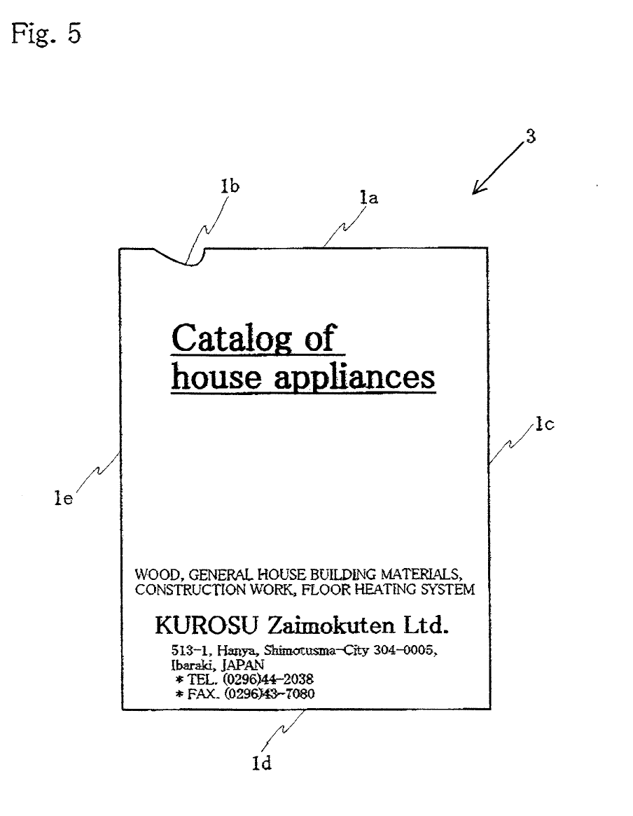

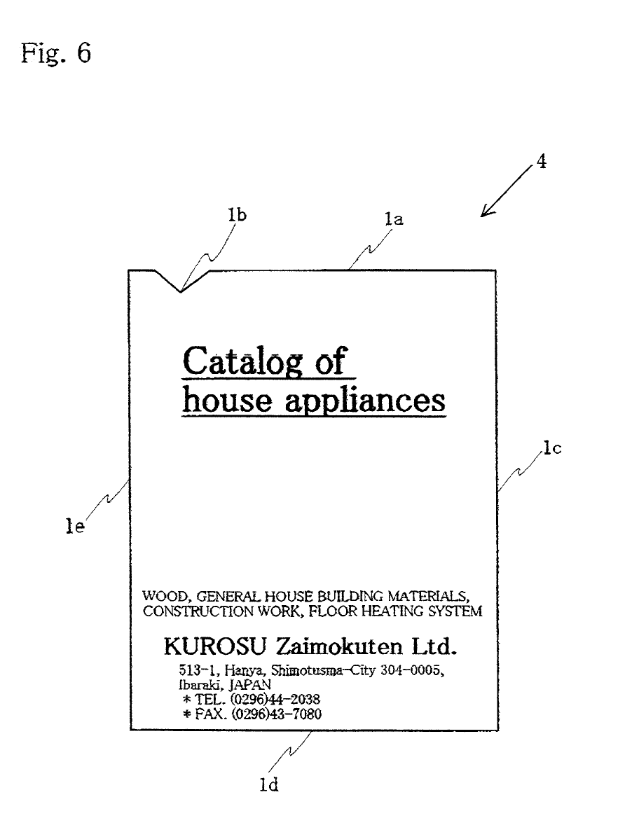

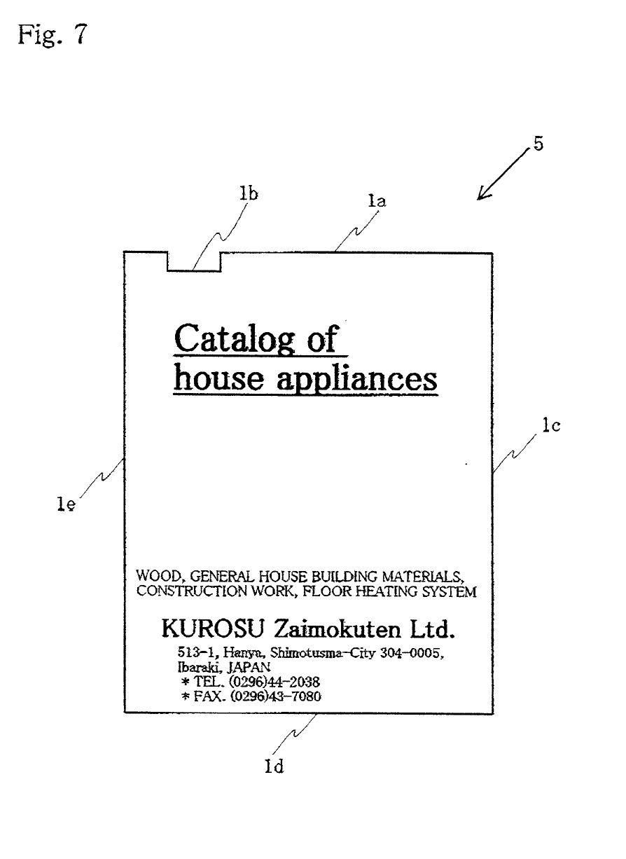

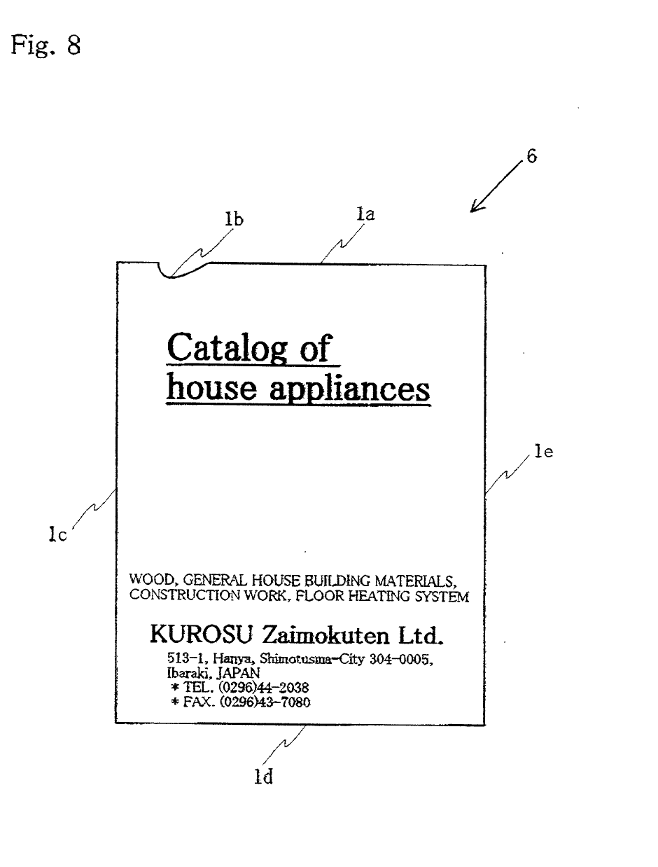

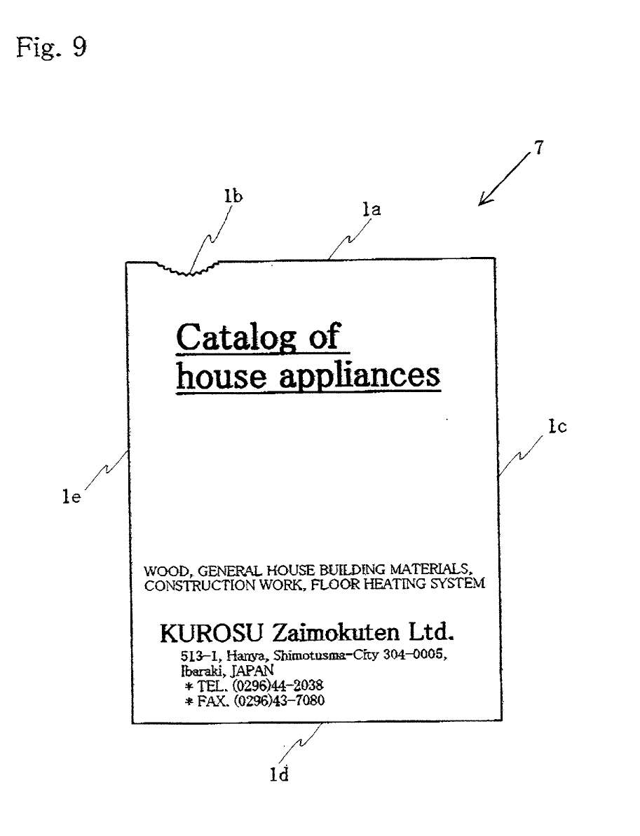

### DESCRIPTION OF REFERENCE NUMERALS

1 stopper-notch-provided product catalog

1a top side

1b stopper notch

1c front side

1d bottom side

1e rear side

2 stopper-notch-provided product catalog storage rack

2a partition shelves

3 stopper-notch-provided product catalog

4 stopper-notch-provided product catalog

5 stopper-notch-provided product catalog

6 stopper-notch-provided product catalog

7 stopper-notch-provided product catalog

8 finger

8a finger tip surface

In the claims:

1. A stopper-notch-provided product catalog characterized in that a stopper notch of a nearly U shape is formed across in a left end portion of a top side at a position of 1.5 cm to 2 cm rightward from a left end in such a way that said stopper notch has a width of about 2 to 3 cm and a surface of a finger tip fits inside.

2. The stopper-notch-provided product catalog according to claim 1, characterized in that said stopper notch has a nearly L shape.

3. The stopper-notch-provided product catalog according to claim 1, characterized in that said stopper notch has a V shape.

4. The stopper-notch-provided product catalog according to claim 1, characterized in that said stopper notch has a rectangular recessed shape.

5. The stopper-notch-provided product catalog according to claim 1, characterized in that said stopper notch has a nearly inverted L shape.

6. The stopper-notch-provided product catalog according to claim 1, characterized in that said stopper notch has a rectangular recess shape.

7. The stopper-notch-provided product catalog according to claim 1, characterized in that said stopper notch has a nearly U shape with recesses and projections.
